(19) United States
(12) Patent Application Publication
(10) Pub. No.: US 2014/0140573 A1
(43) Pub. Date: May 22, 2014

(54) Pose Tracking through Analysis of an Image Pyramid

(71) Applicant: GRAVITY JACK, INC., Liberty Lake, WA (US)

(72) Inventors: Benjamin William Hamming, Spokane, WA (US); Shawn David Poindexter, Coeur d'Alene, ID (US); Marc Andrew Rollins, Spokane, WA (US)

(73) Assignee: GRAVITY JACK, INC., Liberty Lake, WA (US)

(21) Appl. No.: 13/683,902

(22) Filed: Nov. 21, 2012

(51) Int. Cl. G06T 7/20

(52) U.S. Cl. CPC G06T 7/2033
USPC 382/103

(57) ABSTRACT

Techniques for tracking a pose of a textured target in an augmented reality environment are described herein. The techniques may include processing an initial image representing the textured target to generate feature relation information describing associations between features on different image layers of the initial image. The feature relation information may be used to locate features in different image layers of a subsequent image. Upon locating features in a highest resolution image of the subsequent image, the pose of the textured target may be determined for the subsequent image.

### BACKGROUND

A growing number of people are using electronic devices, such as smart phones, tablets computers, laptop computers, portable media players, and so on. These individuals often use the electronic devices to consume content, purchase items, and interact with other individuals. In some instances, an electronic device is portable, allowing an individual to use the electronic device in different environments, such as a room, outdoors, a concert, etc. As more individuals use electronic devices, there is an increasing need to enable these individuals to interact with their electronic devices in relation to their environment.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example architecture to track a pose of a textured target based on feature relation information.

FIG. 2 illustrates further details of the example computing device of FIG. 1.

FIG. 3 illustrates additional details of the example augmented reality service of FIG. 1.

FIGS. 4A-4D illustrate an example process to determine a pose of a textured target through a pyramid analysis.

FIG. 5 illustrates an example process to transform feature relation information to account for a change in scale and/or orientation of a feature.

FIGS. 6A-6B illustrate a example process to generate feature relation information for an initial image and utilize the information to determine a pose of a textured target in a subsequent image.

FIG. 7 illustrates an example process to search for a feature within a particular image layer of an image based on feature relation information.

### DETAILED DESCRIPTION

This application is related to “Feature Searching along a Path of Increasing Similarity” (Attorney Docket No. G041-0003US) and “Feature Searching Based on Feature Quality Information” (Attorney Docket No. G041-0005US), filed concurrently herewith. The entire contents of both are incorporated herein by reference.

This disclosure describes architectures and techniques directed to, in part, tracking a pose of a textured target. In particular implementations, a user may use a portable device (e.g., a smart phone, tablet computer, etc.) to capture images of an environment, such as a room, outdoors, and so on. The images may be processed to identify a textured target in the environment (e.g., surface or portion of a surface) that is associated with augmented reality content. When such a textured target is identified, the augmented reality content may be displayed on the device in an overlaid manner on real-time images of the environment. The augmented reality content may be maintained on the display of the device in relation to the textured target as the device moves throughout the environment. To display the augmented reality content in relation to the textured target, the pose of the textured target may be tracked through the images.

To track a pose of a textured target, a device may capture an initial image of an environment with a camera of the device. The initial image may represent a textured target of the environment, such as a surface or portion of a surface in the environment. The image may be processed to generate multiple image layers representing the image at different resolutions (e.g., a pyramid representation of the image). Feature detection techniques may then be performed on each of the image layers to detect features in each of the image layers. A feature may generally comprise a point of interest in the image, such as a corner, edge, blob, or ridge. Features of a particular image layer, such as a highest resolution image layer, may be processed to identify a pose of the textured target for the initial image.

The device may also generate feature relation information describing associations between features of different image layers. For example, the information may include a vector from a feature in a first image layer (e.g., lower resolution image layer) to a corresponding feature in second image layer (e.g., higher resolution image layer). As used herein, the feature in the first image layer may be described as a “parent feature” to the feature in the second image layer and the feature in the second image layer may be described as a “child feature” to the feature in the first image layer. A child feature is generally located on a higher resolution image layer with respect to the image layer of the parent feature. As such, the child feature may generally have a higher resolution than the parent feature. The device may utilize this feature relation information to detect a pose of the textured target in a subsequent image.

To detect the pose of the textured target in the subsequent image, the device may generate multiple image layers for the subsequent image. The device may then utilize the feature relation information of the initial image to identify features in image layers of the subsequent image that correspond to the features in image layers of the initial image. For example, upon finding a parent feature in a lowest resolution image layer of the subsequent image (e.g., layer 1), the device may reference the feature relation information to identify a general area in a higher resolution image layer of the subsequent image (e.g., layer 2) where a child feature may be found. Upon finding the child feature, the device may reference the feature relation information again to identify a child feature in a yet higher resolution image layer of the subsequent image (e.g., layer 3). This process may continue until features are found in a highest resolution image layer of the subsequent image. Features of the highest resolution layer of the subsequent image may be used to determine the pose of the textured target for the subsequent image. By using the feature relation information, the pose of the textured target may be detected in a subsequent image.

The pose of the textured target may then be used to create an augmented reality experience. For example, the pose may be used to display content on the device in relation to a displayed location of the textured target, such as in an overlaid manner on the textured target. Here, the pose may facilitate the content to be displayed in a plane in which the textured target is located. This may create the perception that the content is part of the environment of the device.

In some instances, by using feature relation information describing relationships between features of different image layers of an initial image, a device may intelligently detect a feature in a subsequent image. For instance, upon locating a parent feature in the subsequent image, the device may use the feature relation information describing a relationship to a child feature in the initial image to identify an area in the subsequent image in which to search for the child feature. This may allow the device to locate the child feature without searching the entire subsequent image. Further, by using feature relation information, the device may locate features that are used to determine a pose of a textured target in an initial image throughout subsequent images. This may allow a pose of the textured target to be accurately tracked throughout the subsequent images.

This brief introduction is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Example Architecture

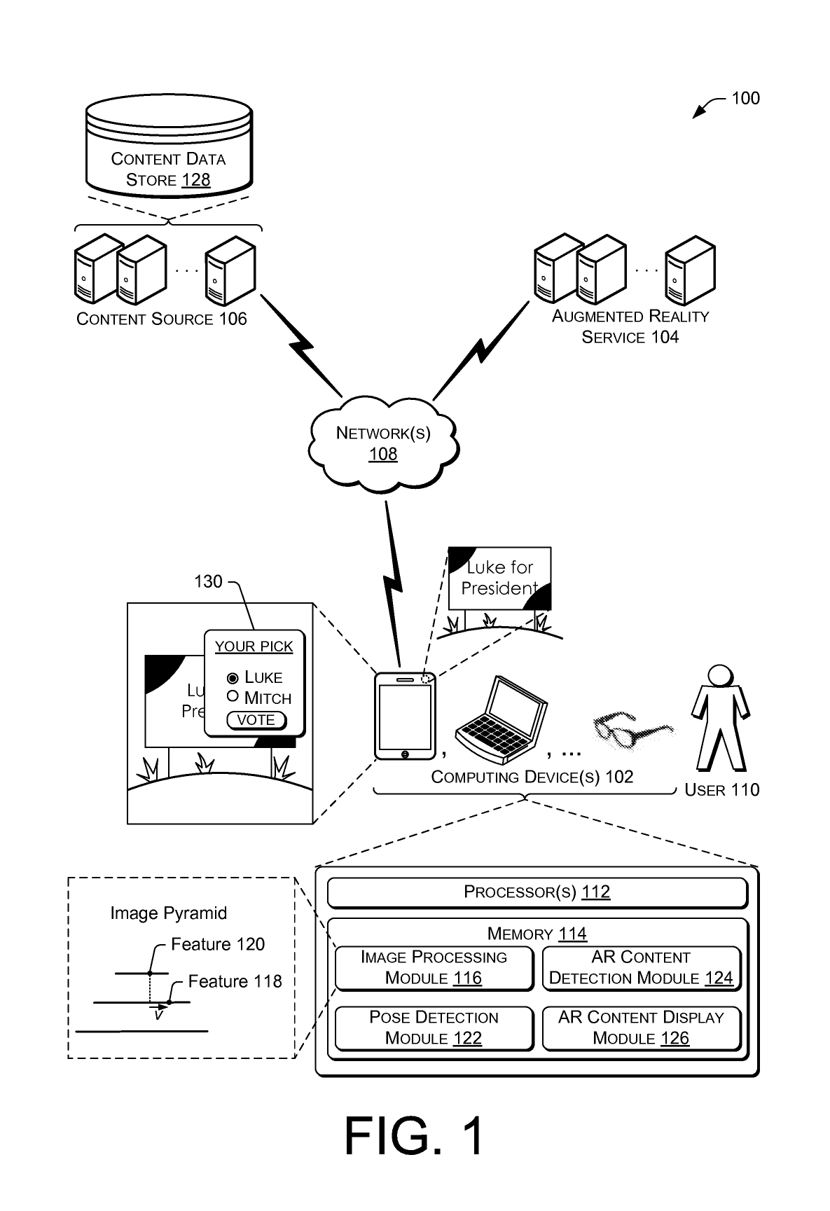

FIG. 1 illustrates an example architecture 100 in which techniques described herein may be implemented. In particular, the architecture 100 includes one or more computing devices 102 (hereinafter the device 102) configured to communicate with an Augmented Reality (AR) service 104 and a content source 106 over a network(s) 108. The device 102 may augment a reality of a user 110 associated with the device 102 by modifying the environment that is perceived by the user 110. In many examples described herein, the device 102 augments the reality of the user 110 by modifying a visual perception of the environment, such as by adding visual content. However, the device 102 may additionally, or alternatively, modify other sense perceptions of the environment, such as a taste, sound, touch, and/or smell.

The device 102 may be implemented as, for example, a laptop computer, a desktop computer, a smart phone, an electronic reader device, a mobile handset, a personal digital assistant (PDA), a portable navigation device, a portable gaming device, a tablet computer, a watch, a portable media player, a hearing aid, a pair of glasses or contacts having computing capabilities, a transparent or semi-transparent glass having computing capabilities (e.g., heads-up display system), another client device, and the like. In some instances, when the device 102 is at least partly implemented by a transparent or semi-transparent glass, such as a pair of glasses, contacts, or a heads-up display, computing resources (e.g., processor, memory, etc.) may be located in close proximity to the glass, such as within a frame of the glasses. Further, in some instance when the device 102 is at least partly implemented by glass, images (e.g., video or still images) may be projected or otherwise provided on the glass for perception by the user 110.

The device 102 may be equipped with one or more processors 112 and memory 114. The memory 114 may include software functionality configured as one or more “modules.” The term “module” is intended to represent example divisions of the software for purposes of discussion, and is not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

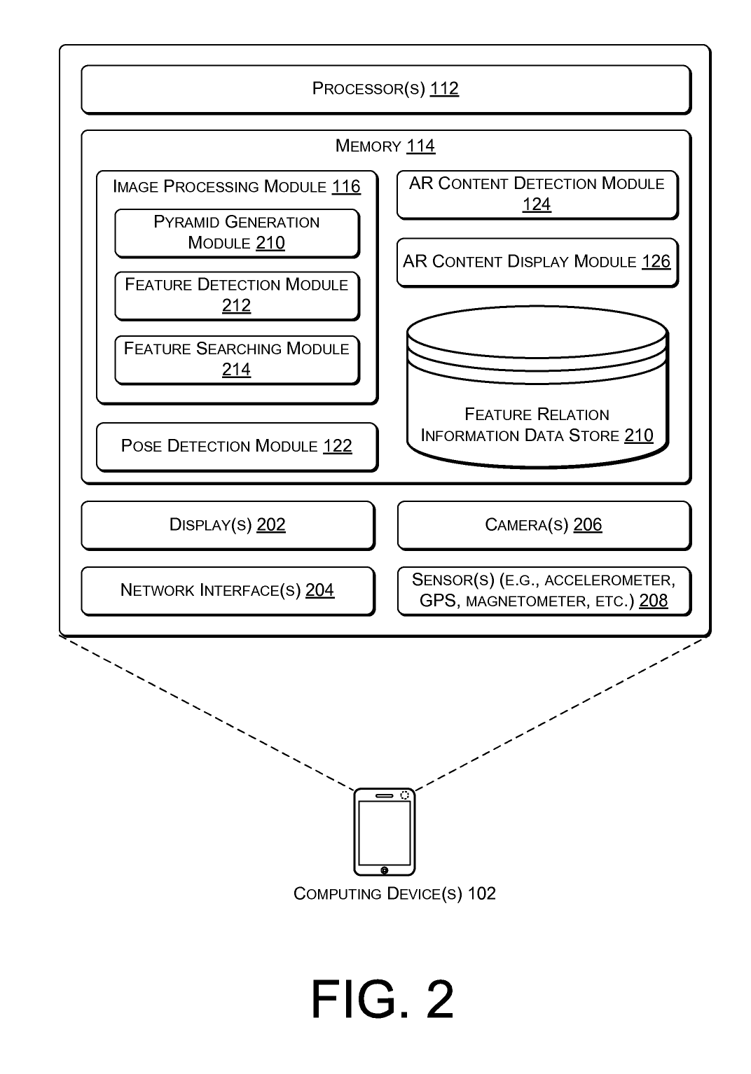

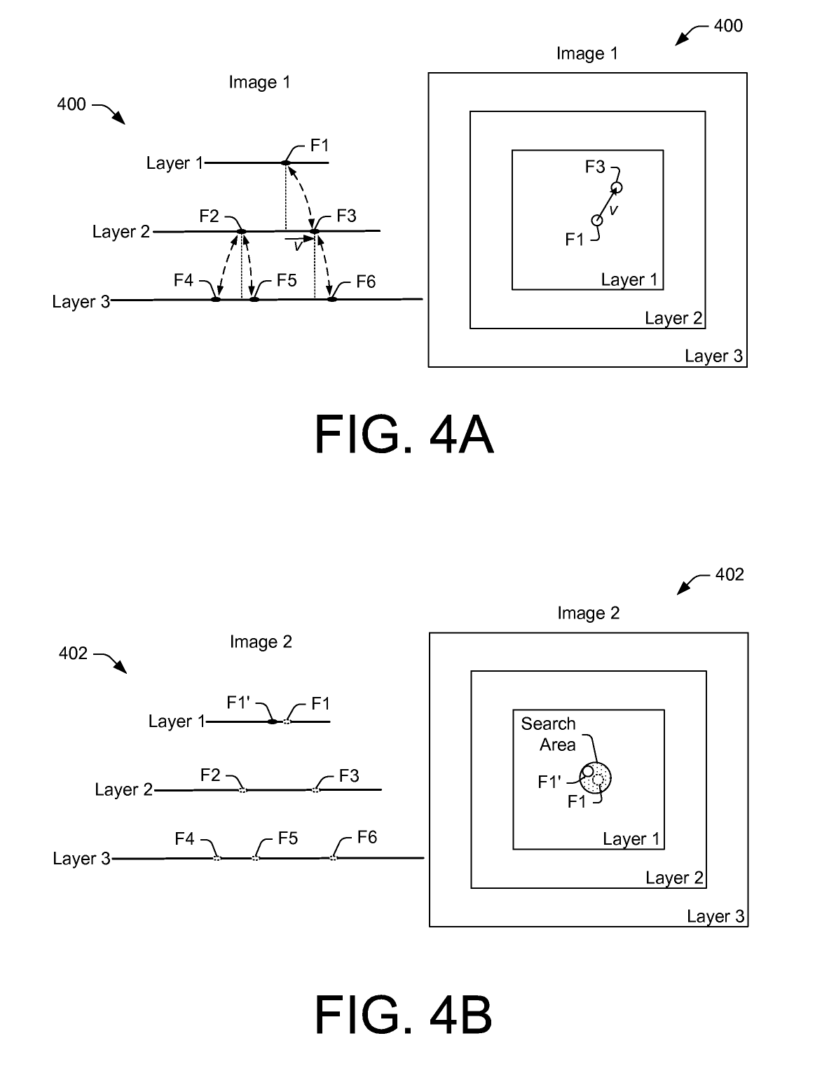

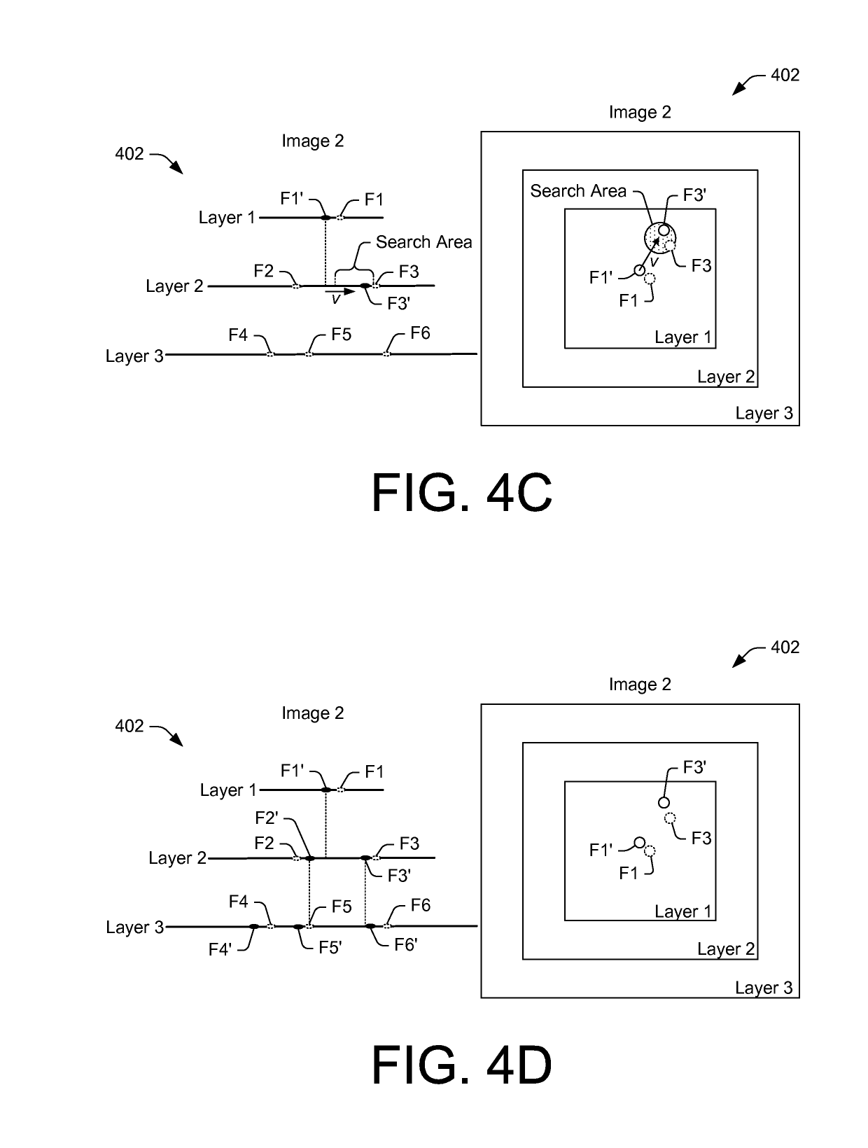

The memory 114 may include an image processing module 116 configured to process one or more images of an environment in which the device 102 is located. The image processing module 116 may generally generate feature relation information (e.g., a vector) describing relations between features on different image layers of an image and utilize the information to find features in different image layers of a subsequent image. For example, as illustrated in FIG. 1, the module 116 may utilize a vector describing a relation of a child feature 118 to a parent feature 120 in a first image (e.g., initial frame) to identify a corresponding child feature in a subsequent image. Further details of the image processing module 116 will be discussed below in reference to FIG. 2, with further reference to FIGS. 4A-4D regarding how the features are recognized.

The memory 114 may also include a pose detection module 122 configured to detect a pose of a textured target. A textured target may generally comprise a surface or a portion of a surface within an environment that has one or more textured characteristics. The module 122 may generally utilize features of an image to determine a pose of a textured target with respect to that image. In some instances, the module 122 may determine a pose once for an image by utilizing features of a particular image layer of an image, such as a highest resolution image layer (e.g., a highest available resolution image layer, such as image layer three of a three layer pyramid, or a highest resolution image layer at which a feature is able to be tracked, such as image layer two of a three layer pyramid). That is, the device 102 may refrain from determining a pose of the textured target for each of the image layers. By doing so, the device 102 may avoid processing associated with determining the pose for multiple image layers. Further details of the pose detection module 122 will be discussed below in reference to FIG. 2.

The memory 114 may additionally include an AR content detection module 124 configured to detect AR content that is associated with an environment of the device 102. The module 124 may generally trigger the creation of an AR experience when one or more criteria are satisfied, such as detecting that the device 102 is located within a predetermined proximity to a geographical location that is associated with AR content and/or detecting that the device 102 is imaging a textured target that is associated with AR content. Further details of the AR content detection module 124 will be discussed below in reference to FIG. 2.

Further, the memory 114 may include an AR content display module 126 configured to control the display of AR content on the device 102. The module 126 may generally cause AR content to be displayed in relation to a real-time image of a textured target in the environment. For example, the module 126 may cause the AR content to be displayed in an overlaid manner on the textured target. In some instances, the module 126 may utilize a pose of the textured target to display the AR content in relation to the textured target. By displaying AR content in relation to a textured target, the module 126 may create a perception that the content is part of an environment in which the textured target is located.

Although the modules 116 and 122-126 are illustrated in the example architecture 100 as being included in the device 102, in some instances one or more of these modules may be included in the AR service 104. In these instances, the device 102 may communicate with the AR service 104 (e.g., send captured images, etc.) so that the AR service 104 may execute the operations of the modules 116 and 122-126. In one example, the AR service 104 is implemented as a remote processing resource in a cloud computing environment with the device 102 merely capturing and displaying images.

The memory 114 (and all other memory described herein) may include one or a combination of computer readable storage media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media includes non-transitory media.

The AR service 104 may generally assist in creating an AR experience through the device 102. For example, the AR service 104 may receive feature descriptors obtained through image processing at the device 102. A feature descriptor may generally describe a detected feature of an image. The AR service 104 may compare the feature descriptor with a library of feature descriptors for different textured targets to identify a textured target that is represented by the feature descriptor. Upon identifying a textured target, the AR service 104 may determine whether or not the textured target is associated with AR content. When AR content is identified, the service 104 may inform the device 102 that AR content is available and/or send the AR content to the device 102. Although the AR service 104 is illustrated in the example architecture 100, in some instances the AR service 104 may be eliminated entirely, such as when all processing is performed locally at the device 102.

Meanwhile, the content source 106 may generally manage content stored in a content data store 128. The content may include any type of content, such as images, videos, interface elements (e.g., menus, buttons, etc.), and so on, that may be used to create an AR experience. As such, the content may be referred to herein as AR content. In some instances, the content is provided to the AR service 104 to be stored at the AR service 104 and/or sent to the device 102. Alternatively, or additionally, the content source 106 may provide content directly to the device 102. In one example, the AR service 104 sends a request to the content source 106 to send the content to the device 102. Although the content data store 128 is illustrated in the architecture 100 as being included in the content source 106, in some instances the content data store 128 is included in the AR service 104 and/or the device 102. As such, in some instances the content source 106 may be eliminated entirely.

In some examples, the content source 106 comprises a third party source associated with electronic commerce, such as an online retailer offering items for acquisition (e.g., purchase). As used herein, an item may comprise a tangible item, intangible item, product, good, service, bundle of items, digital good, digital item, digital service, coupon, and the like. In one instance, the content source 106 offers digital items for acquisitions, including digital audio and video. Further, in some examples the content source 106 may be more directly associated with the AR service 104, such as a computing device acquired specifically for AR content and that is located proximately or remotely to the AR service 104. In yet further examples, the content source 106 may comprise a social networking service, such as an online service facilitating social relationships.

The AR service 104 and/or content source 106 may be implemented as one or more computing devices, such as one or more servers, laptop computers, desktop computers, and the like. In one example, the AR service 104 and/or content source 106 includes computing devices configured in a cluster, data center, cloud computing environment, or a combination thereof.

As noted above, the device 102, AR service 104, and/or content source 106 may communicate via the network(s) 108. The network(s) 108 may include any one or combination of multiple different types of networks, such as cellular networks, wireless networks, Local Area Networks (LANs), Wide Area Networks (WANs), and the Internet.

In one non-limiting example of the architecture 100, the user 110 may operate the device 102 to capture an initial image of a “Luke for President” poster (e.g., textured target). The device may then process the image to generate feature relation information describing feature relations between different image layers of the initial image. Feature descriptors describing the features may be used to recognize the poster and find AR content. In this example, an interface element 130 (e.g., a menu) is identified as being associated with the poster.

Meanwhile, the device 102 captures a subsequent image of the “Luke for President” poster. The subsequent image is analyzed to determine a pose of the poster with respect to the subsequent image. In order to determine an accurate pose of the poster with relatively minimal processing, the device 102 utilizes the feature relation information of the initial image to identify features in different image layers of the subsequent image that correspond to features in the initial image. Upon finding a particular number of features in a highest resolution image layer of the subsequent image, the device 102 may determine the pose of the poster for the subsequent image. The pose of the poster may be used to display the interface element 130 on the device 102 in relation to the poster, such as in an overlaid manner on the poster. Through the interface element 130 the user 110 may indicate who he will vote for as president. By displaying the interface element 130 with the pose of the poster, the interface element 130 may appear as if it is located within the environment of the user 110.

### Example Computing Device

FIG. 2 illustrates further details of the example computing device 102 of FIG. 1. As noted above, the device 102 may generally augment a reality of a user by modifying an environment in which the user is located. In some instances, the device 102 may augment the reality of the user through the assistance of the AR service 104 and/or content source 106, while in other instances the device 102 may operate independent of AR service 104 and/or content source 106 (e.g., perform processing locally, obtain locally stored content, etc.).

The device 102 may include the one or more processors 112, the memory 114, one or more displays 202, one or more network interfaces 204, one or more cameras 206, and one or more sensors 208. In some instances, the one or more displays 202 are implemented as one or more touch screens. The one or more cameras 206 may include a front facing camera and/or a rear facing camera. The one or more sensors 208 may include an accelerometer, compass, gyroscope, magnetometer, Global Positioning System (GPS), olfactory sensor (e.g., for smell), microphone (e.g., for sound), tactile sensor (e.g., for touch), or other sensor.

As noted above, the memory 114 may include the image processing module 116 configured to process one or more images, such as video images. The image processing module 114 may include a pyramid generation module 210, a feature detection module 212, and a feature searching module 214. The modules 210-214 may operate in conjunction with each other to perform various computer vision operations on images from an environment in which the device 102 is located.

The pyramid generation module 210 may be configured to sub-sample and/or smooth an image to create a pyramid representation of the image. A pyramid representation may generally comprise a plurality of image layers that represent an image at different pixel resolutions. In one example, an image is represented by a pyramid representation that includes four image layers, however, in other examples the image may be represented by other numbers of image layers.

The pyramid generation module 210 may also be configured to generate feature relation information describing relations between features on different image layers of an image. The module 210 may begin by associating a parent feature on a lower resolution image layer with a feature on a higher resolution image layer that is located within a predetermined proximity to the parent feature. The feature on the higher resolution image layer may be a child feature to the parent feature. As such, the child feature may represent the parent feature at a higher resolution. Upon associating parent and child features, the module 210 may generate feature relation information indicating a location of the child feature in relation to a location of the parent feature. The feature relation information may be represented in various forms, such as vector, coordinate point(s), and so on. In one example, a vector is used having a magnitude that corresponds to a distance between the parent feature to the child feature and having a direction from the parent feature to the child feature. The feature relation information may be generated upon detecting features in different image layers of an image by the feature detection module 212. The feature relation information may be stored in a feature relation information data store 210.

In some instances, the pyramid generation module 210 may also transform feature relation information by modifying a scale and/or orientation of the feature relation information. As the device 102 moves relative to a textured target, a feature associated with the textured target may change in scale and/or orientation as the feature is located in different images. To utilize feature relation information (e.g., a vector) generated for an initial image in a subsequent image, the feature relation information may be modified in scale and/or orientation.

The feature detection module 212 may analyze an image to detect features of the image. The features may correspond to points of interest in the image, such as a corner, edge, blob, or ridge. In instances where an image is represented by a pyramid representation, the module 212 may detect features in one or more image layers of the pyramid representation. To detect features in an image, the module 212 may utilize one or more feature detection and/or description algorithms commonly known to those of ordinary skill in the art, such as FAST, SIFT, SURF, or ORB. Once a feature has been detected, the detection module 212 may extract or generate a feature descriptor describing the feature, such as a patch of pixels (block of pixels).

The feature searching module 214 may be configured to search an image or image layer to identify (e.g., find) a particular feature (e.g., block of pixels). The search may include comparing blocks of pixels in a subsequent image to a block of pixels in initial image to identify a block of pixels in the subsequent image that has a threshold amount of similarity to the block of pixels of the initial image and/or that most closely matches the block of pixels of the initial image.

The module 214 may generally search within a particular area of an image to find a feature. The particular area may be identified through prediction which may account for a velocity of a textured target and/or through feature relation information which may provide information about features in different image layers. For example, when the module 214 is searching within a first image layer of a subsequent image, the module 214 may predict where a feature of an initial image may be located in the first image layer based on an estimate velocity of the feature relative to the device 102. The module 214 may then search within an area that is substantially centered on the predicted location to find a feature in the first image layer that best matches the feature of the initial image. Further, when the module 214 is searching within a second image layer of the subsequent image, the module 214 may utilize the feature relation information to identify an area in the second image layer in which to search for a child feature to the feature found in the first image layer (e.g., the parent feature).

As noted above, the pose detection module 122 may be configured to detect a pose of a textured target. For example, upon identifying multiple features in an image that represents a textured target, the module 122 may utilize locations of the multiple features to determine a pose of the textured target with respect to that image. In some instances, the module 122 may determine a pose of a textured target once for an image by using features of a particular image layer, such as a highest resolution image layer. The pose for the particular image layer may then represent the pose for that image. The pose may generally indicate an orientation and/or position of the textured target within the environment with respect to a reference point, such as the device 102. The pose may be represented by various coordinate systems (e.g., x, y, z), angles, points, and so on. Although other techniques may be used, in some instances the module 122 determines a pose of a textured target by solving the Perspective-n-Point (PnP) problem, which is generally known by those of ordinary skill in the art.

The AR content detection module 124 may detect AR content that is associated with an environment of the device 102. The module 124 may generally perform an optical and/or geo-location analysis of an environment to find AR content that is associated with the environment. When the analysis indicates that one or more criteria are satisfied, the module 124 may trigger the creation of an AR experience (e.g., cause AR content to be displayed), as discussed in further detail below.

In a geo-location analysis, the module 124 primarily relies on a reading from the sensor 208 to trigger the creation of an AR experience, such as a GPS reading. For example, the module 124 may reference the sensor 208 and trigger an AR experience when the device 102 is located within a predetermined proximity to and/or is imaging a geographical location that is associated with AR content.

In an optical analysis, the module 124 primarily relies on optically captured signal to trigger the creation of an AR experience. The optically captured signal may include, for example, a still or video image from a camera, information from a range camera, LIDAR detector information, and so on. For example, the module 124 may analyze an image of an environment in which the device 102 is located and trigger an AR experience when the device 102 is imaging a textured target, object, or light oscillation pattern that is associated with AR content. In some instances, a textured target may comprise a fiduciary marker. A fiduciary marker may generally comprise a mark that has a particular shape, such as a square or rectangle. In many instances, the content to be augmented is included within the fiduciary marker as an image having a particular pattern (Quick Augmented Reality (QAR) or QR code).

In some instances, the module 124 may utilize a combination of a geo-location analysis and an optical analysis to trigger the creation of an AR experience. For example, upon identify a textured target through analysis of an image, the module 124 may determine a geographical location being imaged or a geographical location of the device 102 to confirm the identity of the textured target. To illustrate, the device 102 may capture an image of the Statue of Liberty and process the image to identity the Statue. The device 102 may then confirm the identity of the Statue by referencing geographical location information of the device 102 or of the image.

In some instances, the AR content detection module 124 may communicate with the AR service 104 to detect AR content that is associated with an environment. For example, upon detecting features in an image through the feature detection module 212, the module 124 may send feature descriptors for those features to the AR service 104 for analysis (e.g., to identify a textured target and possibly identify content associated with the textured target). When a textured target for those feature descriptors is associated with AR content, the AR service 104 may inform the module 124 that such content is available. Although the AR service 104 may generally identify a textured target and content associated with the target, in some instances this processing may be performed at the module 124 without the assistance of the AR service 104.

The AR content display module 126 may control the display of AR content on the display 202 to create a perception that the content is part of an environment. The module 126 may generally cause the AR content to be displayed in relation to a textured target in the environment. For example, the AR content may be displayed in an overlaid manner on a substantially real-time image of the textured target. As the device 102 moves relative to the textured target, the module 126 may update a displayed location, orientation, and/or scale of the content so that the content maintains a relation to the textured target. In some instances, the module 126 utilizes a pose of the textured target to display the AR content in relation to the textured target.

### Example Augmented Reality Service

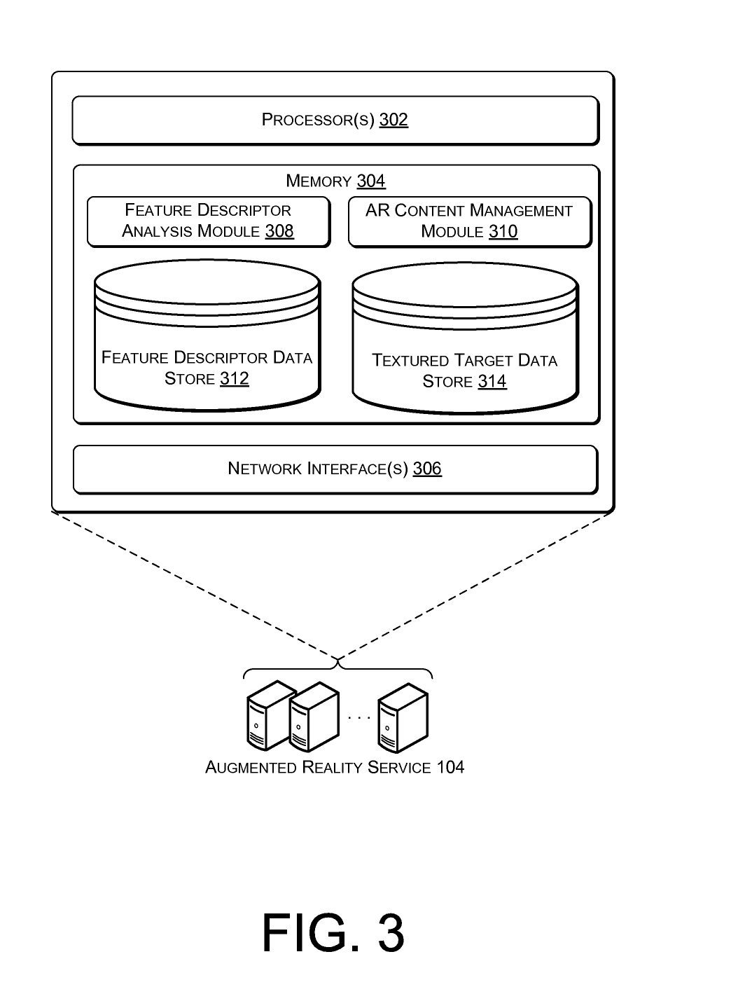

FIG. 3 illustrates additional details of the example AR service 104 of FIG. 1. The AR service 104 may include one or more computing devices that are each equipped with one or more processors 302, memory 304, and one or more network interfaces 306. As noted above, the one or more computing devices of the AR service 104 may be configured in a cluster, data center, cloud computing environment, or a combination thereof. In one example, the AR service 104 provides cloud computing resources, including computational resources, storage resources, and the like in a cloud environment.

As similarly discussed above with respect to the memory 114, the memory 304 may include software functionality configured as one or more “modules.” However, the modules are intended to represent example divisions of the software for purposes of discussion, and are not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

In the example AR service 104, the memory 304 includes a feature descriptor analysis module 308 and an AR content management module 310. The feature analysis module 308 is configured to analyze one or more feature descriptors to identify a textured target. For example, the analysis module 308 may compare a feature descriptor received from the device 102 with a library of feature descriptors of different textured targets stored in a feature descriptor data store 312 to identify a textured target that is represented by the feature descriptor. The feature descriptor data store 312 may provide a link between a textured target and one or more feature descriptors. For example, the feature descriptor date store 312 may indicate one or more feature descriptors (e.g., blocks of pixels) that are associated with the “Luke for President Poster.”

The AR content management module 310 is configured to perform various operations for managing AR content. The module 310 may generally facilitate creation and/or identification of AR content. For example, the module 310 may provide an interface to enable users, such as authors, publishers, artists, distributors, advertisers, and so on, to create an association between a textured target and content. An association between a textured target and content may be stored in a textured target data store 314. In some instances, the AR content management module 310 may aggregate information from a plurality of devices and generate AR content based on the aggregated information. The information may comprise input from users of the plurality of devices indicating an opinion of the users, such as polling information.

The module 310 may also determine whether content is associated with a textured target. For instance, upon identifying a textured target within an environment (through analysis of a feature descriptor as described above), the module 310 may reference the associations stored in the textured target data store 314 to find AR content. To illustrate, Luke may register a campaign schedule with his “Luke for President” poster by uploading an image of his poster and his campaign schedule. Thereafter, when the user 110 views the poster through the device 102, the module 310 may identify this association and provide the schedule to the device 102 for consumption as AR content.

Additionally, or alternatively, the module 310 may modify AR content based on a geographical location of the device 102, profile information of the user 110, or other information. To illustrate, suppose the user 110 is at a concert for a band and captures an image of a CD that is being offered for sale. Upon recognizing the CD through analysis of the image with the feature descriptor analysis module 308, the module 310 may determine that an item detail page for a t-shirt of the band is associated the CD. In this example, the band has indicated that the t-shirt may be sold for a discounted price at the concert. Thus, before the item detail page is sent to the device 102, the list price on the item detail page may be updated to reflect the discount. To add to this illustration, suppose that profile information of the user 110 is made available to the AR service 104 through the express authorization of the user 110. If, for instance, a further discount is provided for a particular gender (e.g., due to decreased sales for the particular gender), the list price of the t-shirt may be updated to reflect this further discount.

### Example Pyramid Analysis

FIGS. 4A-4D illustrate an example process for determining a pose of a textured target through a pyramid analysis. In the process, one or more images may be represented by a pyramid representation that includes three image layers. However, it should be understood that the pyramid representation may include any number of image layers. In FIGS. 4A-4D, each pyramid representation is illustrated with two different types of views. On a left-hand side of each figure, a pyramid representation is illustrated with a side-view, while on a right-hand side the pyramid representation is illustrated from a top view. An image layer towards a top of the pyramid representation (e.g., layer 1) has lower pixel resolution than an image layer towards a bottom of the pyramid representation (e.g., layer 3). The process of FIGS. 4A-4D is described as being performed by the device 102, however, the process may be performed by other devices, such as the AR service 104.

In some instances, the device 102 may initially determine a pose of a textured target represented in an image captured at time t1 (Image 1). The textured target may be located in an environment of the device 102. The pose for the Image 1 may be determined before a pyramid analysis is performed to determine a pose of the textured target in other images, as discussed below in reference to FIGS. 4A-4D. That is, the pose of the textured target for the Image 1 may be determined before the Image 1 is represented as a pyramid representation and/or before feature relation information is generated for the Image 1.

FIG. 4A illustrates an analysis of the Image 1 to generate feature relation information. In analyzing the Image 1, the device 102 may process the Image 1 to generate a pyramid representation 400 representing the Image 1 at different resolutions. Each of the image layers 1-3 may be analyzed to detect features F1-F6. For ease of illustration, the features F2 and F4-F6 are not illustrated on the right-hand side of FIGS. 4A-4D.

Upon detecting the features F1-F6, the device 102 may associate child features on higher resolution image layers to parent features on lower resolution image layers based on proximities of the features to each other. In some instances, a feature may appear (e.g., show-up or be detected) on different image layers. To address this issue, the device 102 may associate parent and child features representing the same feature on different image layers. In general, a child feature may be associated with a closest parent feature. For example, the child feature F3 is associated with the parent feature F1 because the feature F1 is the closest parent feature to the feature F3 (e.g., a projection of the feature F1 onto the layer 2 is the closest parent feature to the feature F3). Similarly, the feature F6 is associated with the feature F3 and the features F4 and F5 are associated with the feature F2. In some instances, a child feature may be associated with multiple parent features. For example, the child feature F5 may be associated with the parent feature F2 and F3 because these parent features are the closest two parent features to the feature F5.

Next, the device 102 may generate feature relation information indicating locations of child features relative to parent features. For example, the device 102 may generate a vector v from the feature F1 in layer 1 to the feature F3 in layer 2 (e.g., from a projection of the feature F1 onto the layer 2 to the feature F3). As illustrated in FIG. 4A, the vector may indicate a distance from the feature F1 to the feature F3 and a direction of the feature F3 relative to the feature F1. In instances where a child feature is associated with multiple parent features, the feature relation information may include a vector for each of the parent features.

FIGS. 4B-4D illustrate an analysis of an image that was captured at time t2 (Image 2). In some instances, the Image 2 corresponds to an image that is captured directly after the Image 1 (e.g., next image), while in other instances one or more images may be captured between the Image 1 and the Image 2. The Image 2 may represent the textured target at time t2.

As illustrated in FIG. 4B, the device 102 may process the Image 2 to generate a pyramid representation 402 representing the Image 2 at different resolutions. Thereafter, the device 102 find a feature F1′ within a lowest resolution image layer for the Image 2 (e.g., image layer 1) that corresponds to the feature F1 from the Image 1. That is, the feature F1′ may represent the feature F1 at time t2 within the Image 2. The device 102 may utilize prediction techniques to identify a search area in image layer 1 of Image 2 and then search in the search area for the feature F1′. The search may include comparing each block of pixels in the search area to a block of pixels that represents the feature F1 to identify a block of pixels that most closely matches or that has a threshold amount of similarity to the block of pixels that represents the feature F1.

Thereafter, as illustrated in FIG. 4C, the device 102 may utilize the feature relation information for Image 1 to identify (e.g., locate) a feature in a next highest resolution image layer of Image 2 (e.g., image layer 2). For example, to identify the feature F3′, the device 102 may align the vector v (that indicates a relation between the features F1 and F3) within the image layer 2 to the feature F1′. As illustrated, the vector v may be aligned to a location of the feature F1′ projected onto the image layer 2 (e.g., directly beneath the location of the feature F1′ in the image layer 1). A search area may then be defined in the image layer 2 at a distal end of the vector v with respect to the feature F1′. The search area may be aligned to be substantially centered on the distal end of the vector. The device 102 may then search within the search area to find the feature F3′ that corresponds to the feature F3 from the Image 1. The feature F3′ may represent the feature F3 at time t2. The search may include comparing each block of pixels in the search area to a block of pixels that represents the feature F3 to identify a block of pixels that most closely matches or that has a threshold amount of similarity to the block of pixels that represents the feature F3.

As illustrated in FIG. 4D, the device 102 may utilize the feature relation information, in a similar manner as discussed with reference to the feature F3′, to locate the features F2′ and F4′-F6′ that correspond to the features F2 and F4-F6. As such, the device 102 may locate features layer-by-layer until all features in a highest resolution image layer are found (e.g., the image layer 3).

The device 102 may then utilize a predetermined number of features of the highest resolution image layer (e.g., image layer 3) to determine a pose of the textured target. For example, the device 102 may utilize a location of the features F4-F6 to solve the Perspective-n-Point problem. For ease of illustration, the PnP problem is solved in this example with three features. However, in many instances the PnP problem may require more than three features, such as four or more features. In some instance, the pose of the textured target may be determined once for each image. Here, the pose may be determined once for the highest resolution image layer of the Image 2. By doing so, the device 102 may avoid determining a pose of the textured target for each image layer, which may consume relatively large amounts of processing time.

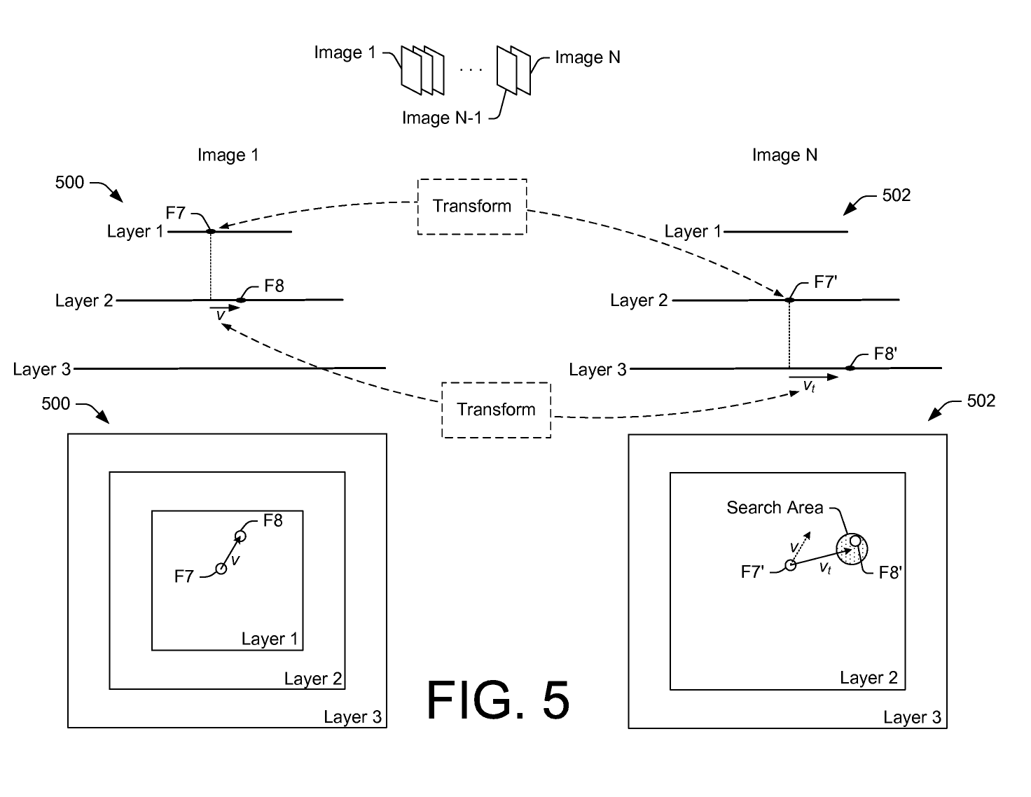

FIG. 5 illustrates an example process of transforming feature relation information to account for a change in scale and/or orientation of a feature. In some instances, as the device 102 moves relative to a textured target, a feature associated with the textured target may change in scale and/or orientation as the feature is located in different images. To utilize feature relation information (e.g., a vector) generated for an initial image in which the feature is detected, the feature relation information may be transformed in a 3-Dimensional (3D) space to account for the change in scale and/or orientation of the feature.

In particular, FIG. 5 illustrates a transform of feature relation information for an initial Image 1 to find a feature in a subsequent Image N. Here, the device 102 may process the Image 1 to generate a pyramid representation 500 and feature relation information for the different image layers of the pyramid representation 500. The feature relation information may comprise a vector v between a parent feature F7 on an image layer 1 and a child feature F8 on an image layer 2.

Thereafter, the device 102 may find features in a subsequent Image N based on information associated with one or more images preceding the Image N. For example, based on a location of the feature F7 in a preceding Image N−1 and a pose a textured target in the preceding Image N−1, the device 102 may determine that the feature F7 has changed in scale and/or orientation with respect to the Image 1 (e.g., the device 102 has zoomed out and panned). As such, the feature F7 may be now be located in the Image N on an image layer 2 with a different orientation. Knowing that the feature has changed in scale and/or orientation, the device 102 may transform the feature F7 by changing a scale and/or orientation of the feature F7 (e.g., shrinking/enlarging, rotating, and/or repositioning the feature F7) so that the feature F7 may be aligned to a scale and/or orientation of the Image N. The device 102 may then search for the feature F7 in the image layer 2 of the Image N. As illustrated, the feature F7 is labeled “F7″” in the Image N.

Upon finding the feature F7′, the device 102 may search for the feature F8 in a higher resolution image layer (e.g., image layer 3). To utilize the feature relation information generated in the Image 1, the device 102 may transform the feature relation information based on a location of the feature F7 in the preceding Image N−1 and the pose the textured target in the preceding Image N−1. The transform may change a scale and/or orientation of the information in 3D space. For example, the device 102 may shrink/enlarge, rotate, and/or reposition the vector v describing the relation between the feature F7 and the feature F8. The transformed feature relation information (e.g., a vector vₜ) may then be used to find a feature F8′ corresponding to the feature F8 in an image layer 3 of the Image N. Here, the device 102 may search for the feature F8′ in a search area that is defined from aligning the vector vₜ to the feature F7′. By transforming feature relation information and/or a feature of an initial image, the device 102 may locate features in subsequent images where the features have changed in scale and/or orientation.

### Example Processes

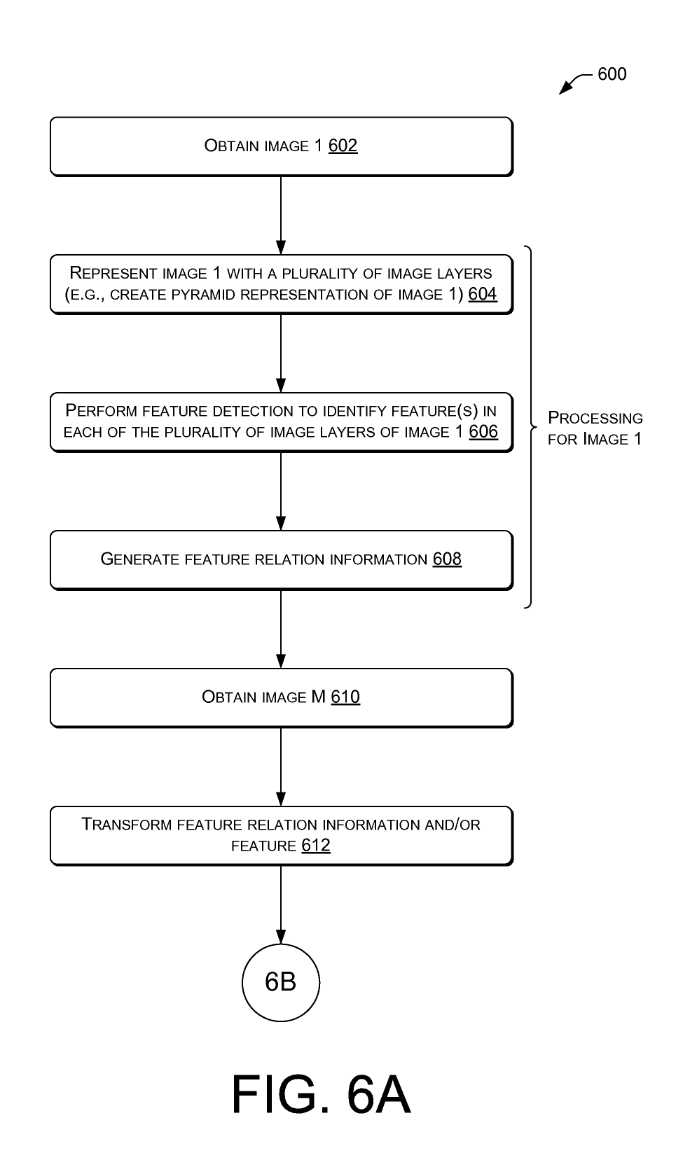

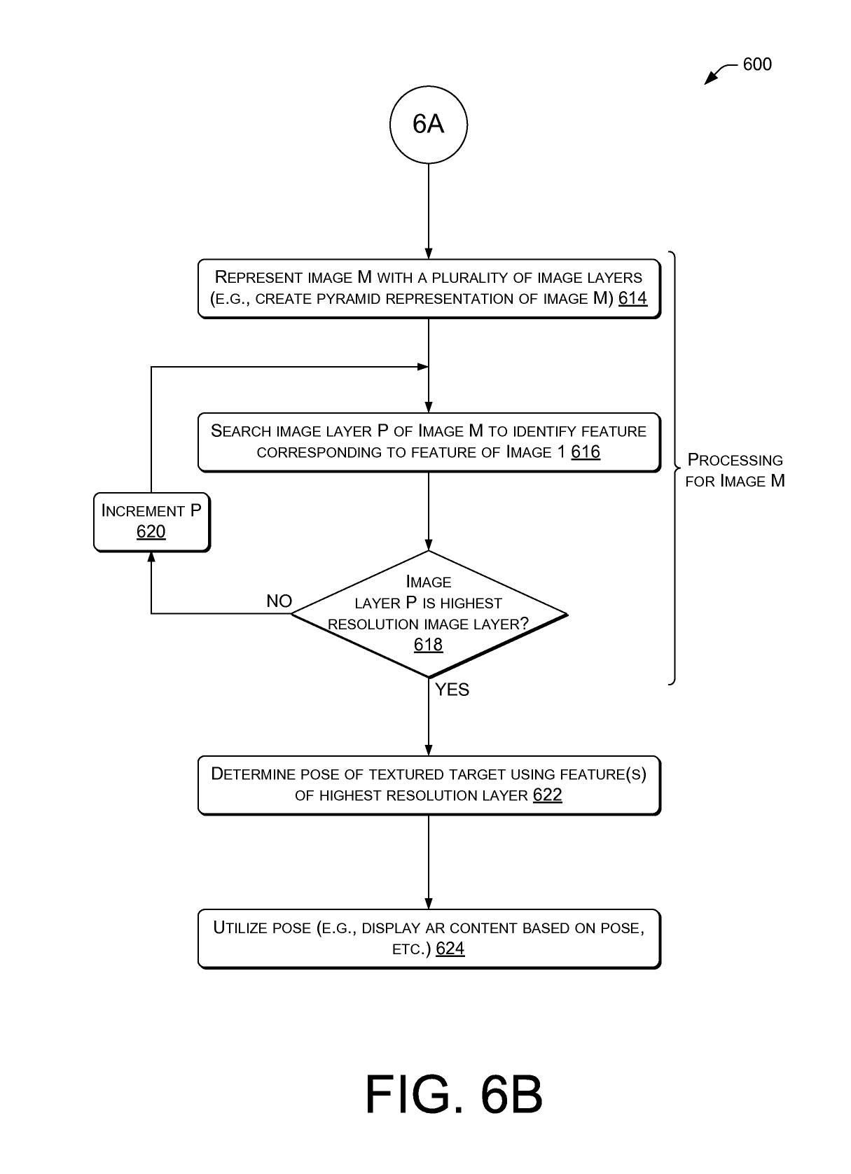

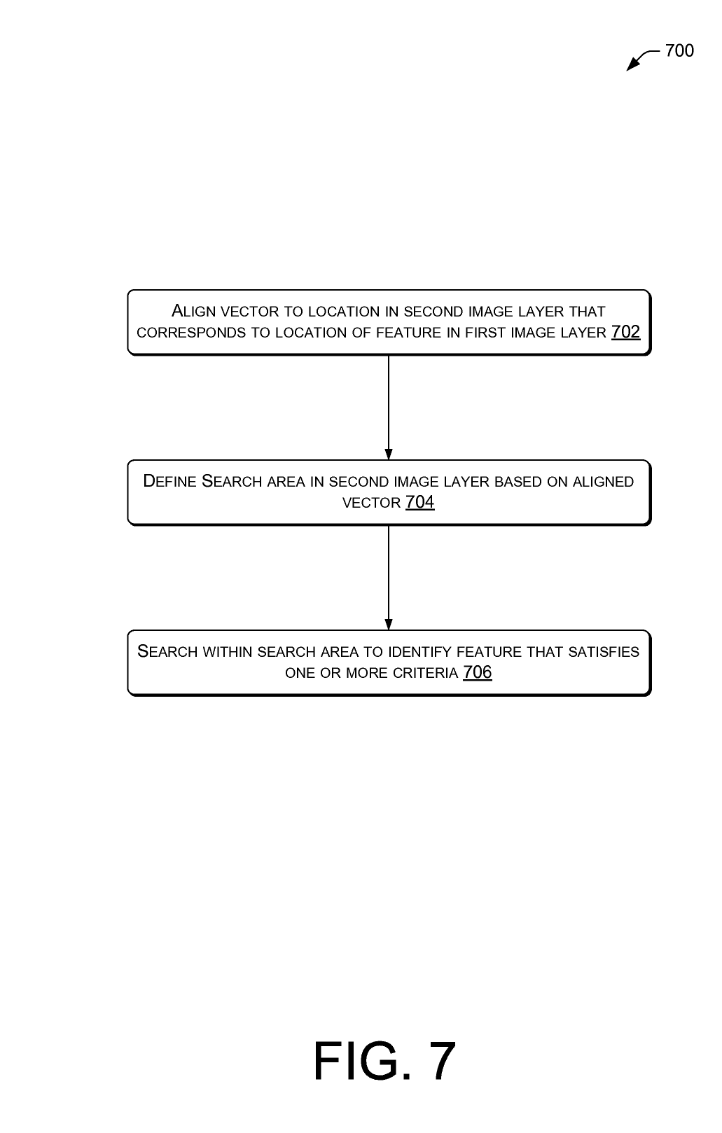

FIGS. 6-7 illustrate example processes 600 and 700 for employing the techniques described herein. For ease of illustration the processes 600 and 700 are described as being performed by the device 102 in the architecture 100 of FIG. 1. However, the processes 600 and 700 may alternatively, or additionally, be performed by the AR service 104 and/or another device. Further, the processes 600 and 700 may be performed in other architectures, and the architecture 100 may be used to perform other processes.

The processes 600 and 700 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. In some instances, any number of the described operations may be omitted.

FIGS. 6A-6B illustrate the example process 600 to generate feature relation information for an initial image and utilize the information to determine a pose of a textured target in a subsequent image.

In FIG. 6A, at 602, the device 102 may obtain (e.g., receive) an image 1 by capturing the image 1 with a camera of the device 102, for example. At 604, the device 102 may represent the image 1 with a plurality of image layers of different resolutions (e.g., produce multiple image layers). That is, the device 102 may create a pyramid representation for the image 1 that includes a particular number of image layers.

At 606, the device 102 may perform feature detection on each the plurality of image layers of the image 1 to identify (e.g., find) one or more features in each of the image layers. Then, at 608, the device 102 may generate feature relation information describing relations between features on different image layers of the plurality of image layers of the image 1. For example, the feature relation information may indicate a location of a feature in a second image layer of the plurality of image layers of the image 1 in relation to a location of a feature in a first image layer of the plurality of image layers of the image 1.

At 610, the device 102 may obtain (e.g., receive) an image M by capturing the image M with the camera of the device 102, for example. The image M may be captured directed after capturing the image 1 or may be captured after any number of images are captured.

At 612, the device 102 may transform the feature relation information and/or a particular feature of image 1. In some instances, a feature may change location, scale, and/or orientation between one or more images (e.g., frames). Thus, in order to account for such a change, a transform may be performed. The transform may be based on a location of the particular feature in a preceding image (e.g., Image M−1) and/or a pose a textured target in the preceding image. The transform may change a scale and/or orientation of the feature information and/or particular feature based on an amount of change in location, scale, and/or orientation of the feature relation information and/or particular feature from the image 1 to the preceding image. By transforming the feature relation information and/or particular feature, the feature relation information and/or particular feature of image 1 may be used to find a feature in the image M.

In FIG. 6B, at 614, the device 102 may represent the image M with a plurality of image layers of different resolutions (e.g., produce multiple image layers). That is, the device 102 may create a pyramid representation for the image M that includes a particular number of image layers.

At 616, the device 102 may search within an image layer P of the image M to identify a feature that corresponds to a feature in the image 1. When the operation 616 is being performed for a first time with respect to the image M, the device 102 may search within the image layer P based on an estimation as to where the feature of the image 1 may be located in the image layer P of the image M, such as in the example of FIG. 4B.

At 618, the device 102 may determine whether or not the image layer P is the highest resolution image layer for the image M. For example, the device 102 may determine whether the image layer P is the highest resolution image layer available or whether the image layer P is a highest resolution image layer at which a particular number of features are tracked or detected, such as in the case when an image is blurry.

When, at 618, the image layer P is not the highest resolution image layer, the process 600 may increment P at 620 and return to the operation 616. At 616, the device 102 may search in a next highest resolution image layer of the image M for a feature that corresponds to a feature in the image 1. Here, the device 102 may search for a child feature that corresponds to a parent feature in a higher resolution image layer of the image M. The device 102 may perform the search based on the feature relation information for the image 1, such as in the example of FIG. 4C. In some instances, such as when one or more images are located between the image 1 and the image M, the search may be based on transformed feature relation information and/or a transformed feature of image 1. The process 600 may loop through the operations 616-620 until a current image layer is a highest resolution image layer for the image M. This may allow the device 102 to find features in each of the image layers of the image M.

When the image layer P is the highest resolution image layer at 618, the process 600 may proceed to 622. At 622, the device 102 may determine a pose of a textured target represented in the image M. In some instances, the pose may be determined by solving the PnP problem with a plurality of features of the highest resolution image layer of the image M. The pose may be representative for the entire image M. As such, in some instances the pose may be determined once for the image M while avoiding processing time associated with multiple pose detections.

At 624, the device 102 may utilize the pose of the textured target. In one example, the pose is used to display AR content on the device 102 in relation to the textured target. For instance, the AR content may be displayed in a plane of the textured target based on the pose to create a perception that the content is part of an environment in which the textured target is located.

FIG. 7 illustrates the example process 700 to search for a feature within a particular image layer of an image based on feature relation information. In some instances, the process 700 may be performed at 618 in FIG. 6B. For example, the process 700 may be performed when the operation 618 is performed to find a child feature in an image layer of the image M.

At 702, the device 102 may align a vector (e.g., feature relation information) to a location in a second image layer of an image that corresponds to a location of a feature in a first image layer of the image. That is, the vector may be aligned in the second image layer to a projected location of a parent feature of the first image layer onto the second image layer. The second image layer may have higher resolution than the first image layer.

At 704, the device 102 may define a search area in the second image layer based on the aligned vector. The search area may be defined at a distal end of the vector relative to the projected location of the parent feature. The search area may comprise a circle, ellipse, quadrilateral, or other shape having one or more predefined dimensions, such as a particular pixel radius.

At 706, the device 102 may search within the search area to identify (e.g., find) a feature that satisfies one or more criteria. For example, the search may include comparing a block of pixels representing a feature in an initial image to each block of pixels in the search area to find a block of pixels that has a threshold amount of similarity and/or that most closely matches the block of pixels representing the feature in the initial image.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
under control of a computing device configured with computer-executable instructions,
capturing, with a camera of the computing device, a first image that at least partly represents a textured target in an environment in which the computing device is located;
generating a plurality of image layers for the first image, the plurality of image layers of the first image representing the first image at different resolutions;
detecting one or more features in each image layer of the plurality of image layers of the first image;
identifying a vector from a feature in a first image layer of the plurality of image layers of the first image to a feature in a second image layer of the plurality of image layers of the first image;
capturing a second image with the camera of the computing device;
generating a plurality of image layers for the second image, the plurality of image layers of the second image representing the second image at different resolutions;
based at least in part on the vector, searching a particular area in an image layer of the plurality of image layers of the second image to identify a feature that corresponds to the feature in the second image layer of the plurality of image layers of the first image; and
determining a pose of the textured target based at least in part on the identified feature in the image layer of the plurality of image layers of the second image.

2. The method of claim 1, further comprising:
utilizing the pose of the textured target to display augmented reality content on a display of the computing device in relation to a displayed location of the textured target.

3. The method of claim 1, wherein the first image layer of the plurality of image layers of the first image has a lower resolution than the second image layer of the plurality of image layers of the first image.

4. The method of claim 1, wherein searching the particular area in the image layer of the plurality of image layers of the second image comprises:
aligning the vector to a location in a second image layer of the plurality of image layers of the second image that corresponds to a location of a feature in a first image layer of the plurality of image layers of the second image;
defining a search area in the second image layer of the plurality of image layers of the second image based at least in part on the aligned vector; and
searching within the search area to identify a feature in the second image layer of the plurality of image layers of the second image that corresponds to the feature in the second image layer of the plurality of image layers of the first image.

5. The method of claim 1, further comprising:
before capturing the second image, capturing a third image with the camera of the computing device;
generating a plurality of image layers for the third image, the plurality of image layers of the third image representing the third image at different resolutions;
based at least in part on the vector, identifying a feature in an image layer of the plurality of image layers of the third image that corresponds to the feature in the second image layer of the plurality of image layers of the first image; and
transforming the vector based at least in part on one or more characteristics of the feature in the image layer of the plurality of image layers of the third image,
wherein the feature in the image layer of the plurality of image layers of the second image is identified based at least in part on the transformed vector.

6. The method of claim 5, wherein the one or more characteristics of the feature in the image layer of the plurality of image layers of the third image comprise:
an orientation of the feature in the image layer of the plurality of image layers of the third image with respect to the feature in the second image layer of the plurality of image layers of the first image; and/or
a scale of the feature in the image layer of the plurality of image layers of the third image with respect to the feature in the second image layer of the plurality of image layers of the first image.

7. A method comprising:
under control of a computing device configured with computer-executable instructions,
obtaining first and second images that at least partly represent a textured target;
representing the first image with a plurality of image layers of different resolutions, the plurality of image layers of the first image comprising at least a first image layer and a second image layer;
generating feature relation information indicating a location of a feature in the second image layer of the plurality of image layers of the first image in relation to a location of a feature in the first image layer of the plurality of image layers of the first image;
representing the second image with a plurality of image layers of different resolutions;
based at least in part on the feature relation information, identifying a feature in an image layer of the plurality of image layers of the second image that corresponds to the feature in the second image layer of the plurality of image layers of the first image; and
determining a pose of the textured target based at least in part on the identified feature in the image layer of the plurality of image layers of the second image.

8. The method of claim 7, further comprising:
utilizing the pose of the textured target to display augmented reality content in relation to the textured target, the augmented reality content being displayed simultaneously with a substantially real-time image.

9. The method of claim 7, wherein the feature relation information describes a vector from the feature in the first image layer of the plurality of image layers of the first image to the feature in the second image layer of the plurality of image layers of the first image.

10. The method of claim 9, wherein identifying the feature in the image layer of the plurality of image layers of the second image comprises:
aligning the vector to a location in a second image layer of the plurality of image layers of the second image that corresponds to a location of a feature in a first image layer of the plurality of image layers of the second image;
defining a search area in the second image layer of the plurality of image layers of the second image based at least in part on the aligned vector; and
searching within the search area to identify a feature in the second image layer of the plurality of image layers of the second image that corresponds to the feature in the second image layer of the plurality of image layers of the first image.

11. The method of claim 9, further comprising:
obtaining a third image, the third image being captured before the second image;
detecting a feature in an image layer of a plurality of image layers of the third image that corresponds to the feature in the second image layer of the plurality of image layers of the first image; and
transforming the vector based at least in part on the feature in the image layer of the plurality of image layers of the third image,
wherein the feature in the image layer of the plurality of image layers of the second image is identified based at least in part on the transformed vector.

12. The method of claim 11, wherein the transforming the vector comprises changing a scale and/or orientation of the vector based at least in part on a scale and/or orientation of the feature in the image layer of the plurality of image layers of the third image.

13. The method of claim 7, wherein determining the pose of the textured target comprises utilizing the identified feature in the image layer of the plurality of image layers of the second image and one or more other features in the image layer of the plurality of image layers of the second image to solve the Perspective-n-Point problem.

14. One or more computer-readable storage media storing computer-readable instructions that, when executed, instruct one or more processors to perform the method of claim 7.

15. A system comprising:
one or more processors; and
memory, communicatively coupled to the one or more processors, storing executable instructions that, when executed by the one or more processors, cause the one or more processors to perform acts comprising:
obtaining first and second images that at least partly represent a textured target;
representing the first image with a plurality of image layers of different resolutions, the plurality of image layers of the first image comprising at least a first image layer and a second image layer;
detecting one or more features in each image layer of the plurality of image layers of the first image;
generating feature relation information indicating a location of a feature in the second image layer of the plurality of image layers of the first image in relation to a location of a feature in the first image layer of the plurality of image layers of the first image;
representing the second image with a plurality of image layers of different resolutions;
based at least in part on the feature relation information, identifying a feature in an image layer of the plurality of image layers of the second image that corresponds to the feature in the second image layer of the plurality of image layers of the first image; and
determining a pose of the textured target based at least in part on the detected feature in the image layer of the plurality of image layers of the second image.

16. The system of claim 15, wherein the feature relation information describes a vector from the feature in the first image layer of the plurality of image layers of the first image to the feature in the second image layer of the plurality of image layers of the first image.

17. The system of claim 16, wherein identifying the feature in the image layer of the plurality of image layers of the second image comprises:
aligning the vector to a location in a second image layer of the plurality of image layers of the second image that corresponds to a location of a feature in a first image layer of the plurality of image layers of the second image;
defining a search area in the second image layer of the plurality of image layers of the second image based at least in part on the aligned vector; and
searching within the search area to identify a feature in the second image layer of the plurality of image layers of the second image that corresponds to the feature in the second layer of the plurality of image layers of the first image.

18. The system of claim 16, wherein the acts further comprise:
before identifying the feature in the image layer of the plurality of image layers of the second image, transforming the vector by changing a scale and/or orientation of the vector.

19. The system of claim 15, wherein determining the pose of the textured target comprises utilizing the identified feature in the image layer of the plurality of image layers of the second image and one or more other features in the image layer of the plurality of image layers of the second image to solve the Perspective-n-Point problem.

20. The system of claim 15, wherein:
the image layer of the plurality of image layers of the second image comprises an image layer from among the plurality of image layers that has a highest resolution; and
determining the pose of the textured target comprises determining the pose of the textured target with respect to the image layer of the plurality of image layers of the second image while refraining from determining the pose of the textured target with respect to other image layers of the plurality of image layers of the second image.

21. One or more computer-readable storage media storing computer-readable instructions that, when executed, instruct one or more processors to perform operations comprising:
receiving first and second images that at least partly represent a textured target;
producing multiple layers for each of the first and second images, the multiple layers representing the respective image at different resolutions; and
identifying a feature in a layer of the multiple layers of the second image from a relation of features in the multiple layers of the first image to determine a pose of the textured target.

22. The one or more computer-readable storage media of claim 21, wherein the operations further comprise:
utilizing the pose of the textured target to display augmented reality content in relation to the textured target, the augmented reality content being displayed simultaneously with a substantially real-time image.

23. The one or more computer-readable storage media of claim 21, wherein the layer of the multiple layers of the second image has a higher resolution than another layer of the multiple layers of the second image.
